(19) United States
(12) Patent Application Publication
(10) Pub. No.: US 2016/0053980 A1
(43) Pub. Date: Feb. 25, 2016

(54) Portable cordless illustration tablet

(71) Applicant: Alexander Milton Uphoff, Seattle, WA (US)

(72) Inventor: Alexander Milton Uphoff, Seattle, WA (US)

(21) Appl. No.: 14/121,336

(22) Filed: Aug. 21, 2014

(51) Int. Cl. F21V 23/04; F21L 4/08

(52) U.S. Cl. CPC F21V 23/0414; F21L 4/08; F21Y 2101/02

(57) ABSTRACT

The Portable Cordless Illustration Tablet outlines the design and construction of a low power LED array and required housing and controls to make a low profile, battery powered, portable light table.

### CROSS REFERENCES

### Background of the Invention

The invention is a cordless portable desk top illustration tablet for making timely convenient tracings of technical illustrations and graphical data. The invention provides a portable cordless means for viewing and inspecting photographs and physical data in the field under conditions of enhanced lighting where close scrutiny or immediate determination is required. Under these circumstances the convenience of a portable cordless illustration tablet to make accurate copies of drawings and tracings of items of evidential significance at or near their point of occurrence is important, particularly where a myriad of incidents have simultaneously occurred. These types of observations are more accurately assembled near the time of occurrence when documented by tracing in place. Such assessments become less sensitive to time delay and memory distortion when compiled at a later time.

### Summary of the Invention

The portable cordless illustration tablet hereafter referred to as the Lightboard is a low profile unit which backlights a workspace for tracing application in technical and artistic fields.

Light emitting diodes (LEDs) allow the light source to be broadly distributed so the distance required to achieve even light distribution can be very short, which allows the unit to be compact, and their low power consumption allows for the easy use of battery power to enhance a portable graphical capability in the field.

The central element of the Lightboard is the LED array shown FIG. 4. For uniform lighting, the LED should be a staggered “diamond” pattern with diodes spaced apart by no more than shown in FIG. 5. LEDs shown in FIGS. 4 and 5 are set in series of three for 9.6V input, but may be altered to suit other input voltages. The current-limiting resisters would need to be changed for any new input voltage.

The LED panel is mounted to the bottom of a shallow housing, shown in FIGS. 1 through 3. This housing provides a standoff distance of 13.7 mm between the LED panel and an acrylic or glass work surface. The inside surface of the work surface is made to diffuse light by etching, abrasion, or the application of a translucent film. Also contained in the housing is a rechargeable battery pack. The low power consumption the LED panel allows the unit to be self-contained, permitting true portability.

### DRAWINGS

7 drawings are presented to illustrate how the completed Portable Cordless Illustration Tablet (Lightboard) works.

FIG. 1 shows the plan view of the housing with labeled cavities: the LED array compartment, controls space, and the battery compartment.

FIG. 2 is the bottom view relative to plan view, showing clip slots.

FIG. 3 is a section view of standoff distance between LEDs and work surface.

FIG. 4 is plan view showing the LED array, which includes current-limiting resisters.

FIG. 5 is the detail of the LED array illustrating optimal spacing between LEDs for uniform lighting.

FIG. 6 is a schematic of the wiring of the LEDs with a single switch control.

FIG. 7 is a schematic of wiring with dual switch control, on/off and high/low settings with dimmer switch operating at set value.

FIG. 8 is a schematic of wiring with dual switch control, on/off and high/low settings with dimmer switch potentiometer driven.

### DETAILED DESCRIPTION OF THE INVENTION

The Portable Cordless Illustration Table or Lightboard consists of an LED panel, battery, power/dimmer circuit, housing, and cover.

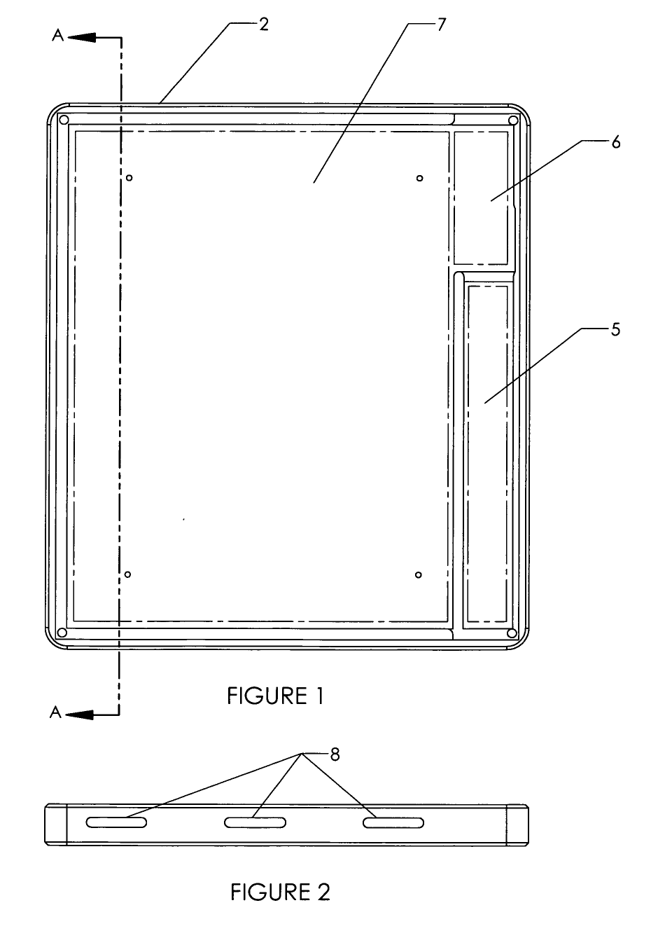

FIGS. 1 and 2 show a cover, or work window 1, which diffuses light and is smooth on at least one side, which faces outward. Acrylic material is preferable for a portable unit since it is more durable than glass. It can be made to diffuse light one of several ways, the inner face can be etched or abraded, or a light diffusing film, such as a simple window privacy film, can be applied.

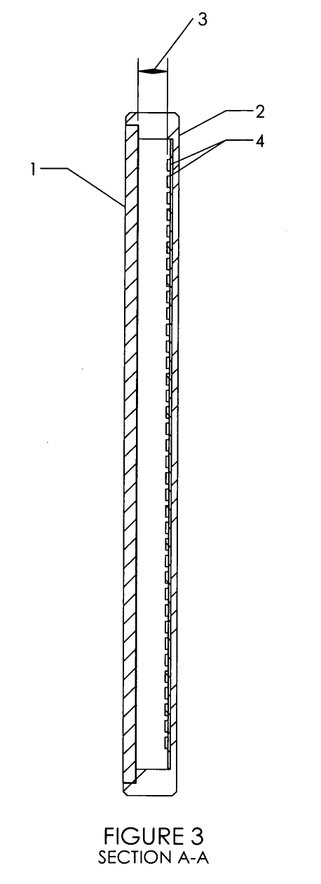

FIGS. 1 through 3 display the housing 2, which is one piece of molded plastic to which all of the other components are mounted. It provides standoff 3, a distance of 13.7 millimeters, between LEDs 4 and work surface 1 shown in FIG. 3. The housing 2 has three cavities, as shown in FIG. 1; one is the battery compartment 5, a second is for the control hardware 6, and a third, main cavity is the LED 4 array compartment 7. In FIG. 2 are slots 8 shown in the sides of the housing to facilitate the use of binder or other clips to affix the users' work to the unit repeatedly and without harm to delicate paper products.

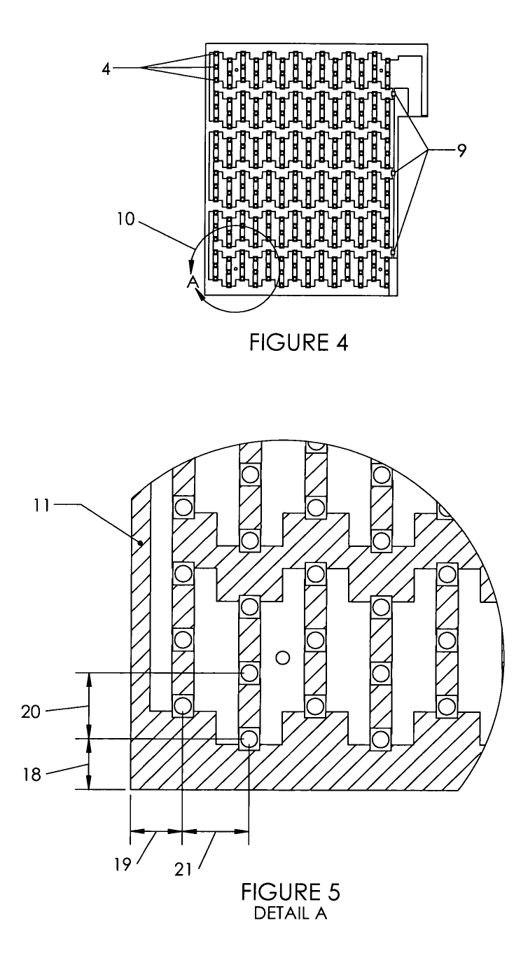

FIG. 4 shows how the LED 4 panel allows for the broad distribution of light source, making uniform lighting achievable in a much shorter distance than conventional light tables. Current limiting resistors 9 are also shown.

FIG. 5 shows the staggered diode pattern which yields excellent initial light distribution. The vertical edge spacing 18 is 12.3 millimeters and the horizontal edge spacing 19 is 12.4 millimeters. Vertical spacing 20 between LEDs 4 is 15.9 millimeters. Horizontal spacing 21 between columns is 15.6 millimeters.

9.6 volts was selected as the input for two reasons: LEDs commonly operate in the 3v range, so it is very easy to source LEDs to set in series of three to accept this voltage input. Also, standard, high-capacity rechargeable batteries are commonly 1.2v, so it is also very easy to source a stack of 8 batteries to meet voltage and capacity requirements for the unit.

FIG. 6 is an electrical schematic of LEDs 4 operated by a single switch 13 between states “on” and “charge”. In “charge” state, LEDs 4 are off, and batteries are recharged by charger 12.

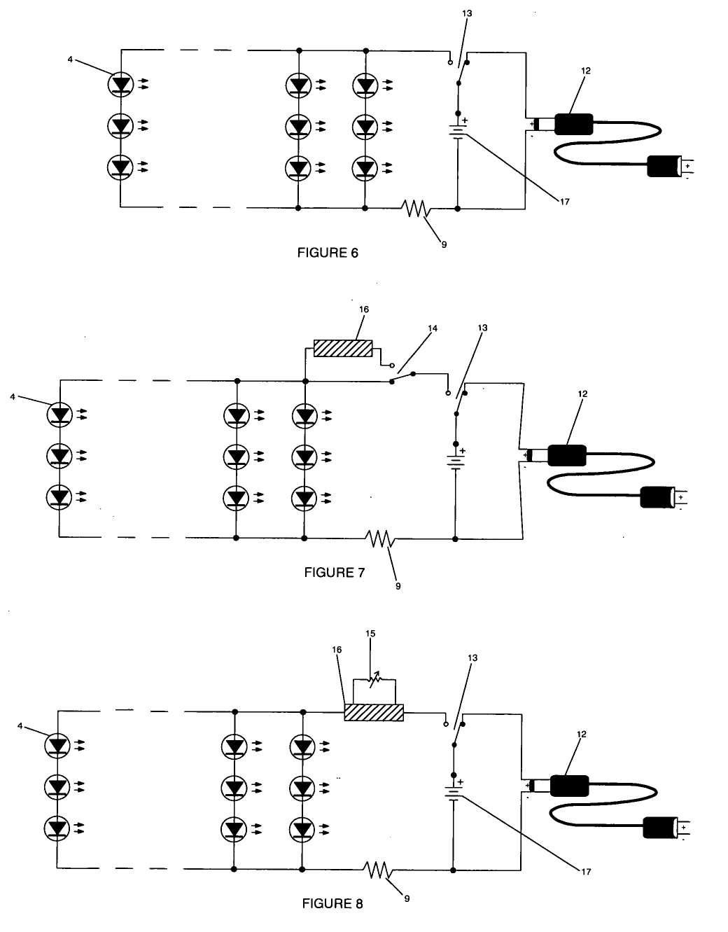

FIG. 7 and FIG. 8 include dimmer 16. The dimmer 16 should be a high frequency pulse bandwidth modulator (PBM). This type of dimmer will extend battery life by allowing the user to adjust the brightness to suit ambient light conditions.

FIG. 7 is an electrical schematic of LEDs 4 operated by two switches. Switch 13 changes between “on” and “charge” states, as above. Switch 14 changes between “high” and “low” states.

FIG. 8 is an electrical schematic of LEDs 4 operated by switch 13 and potentiometer 15. Switch 13 changes between “on” and “charge” states, as above. The dimmer 16 incorporates potentiometer 15 allowing more precise brightness adjustment.

### DRAWING ELEMENTS

1. Work window (cover)
2. Housing
3. Standoff
4. LED lights
5. Battery compartment
6. Space for controls
7. LED array compartment
8. Clip slots (bottom view)
9. Current limiting resisters
10. “A” showing the detail section of FIG. 4
11. Copper
12. Charger
13. Switch for “on” and “charge” states
14. Switch for “high” and “low” states with a fixed brightness dimmer
15. Potentiometer for adjusting dimmer
16. Dimmer
17. Batteries
18. Vertical edge spacing, 12.3 mm
19. Horizontal edge spacing, 12.4 mm
20. Vertical spacing, 15.9 mm
21. Horizontal spacing, 15.6 mm

What is claimed is:

1. A Portable Cordless Illustration Tablet consisting of LED lighting array which allows for the distribution the light, an acrylic cover, molded plastic housing, rechargeable batteries, and controlled by a switch which toggles between On and Off/charge positions.

2. The tablet controlled by the switch above and a dimmer of set io value.

3. The tablet controlled by the switch above and a dimmer using a potentiometer allowing more precise brightness adjustments.
